(19) United States
(12) Patent Application Publication
(10) Pub. No.: US 2006/0145126 A1
(43) Pub. Date: Jul. 6, 2006

(54) Perovskite material, preparation method and use in catalytic membrane reactor

(76) Inventors: Thierry Chartier, Feytiat (FR); Pascal Del Gallo, Dourdan (FR); Gregory Etchegoyen, Rilhac-Rancon (FR)

Correspondence Address: AIR LIQUIDE, 2700 POST OAK BOULEVARD, SUITE 1800, HOUSTON, TX, 77056, US

(21) Appl. No.: 10/562,521

(22) PCT Filed: Jul. 8, 2004
(86) PCT No.: PCT/FR04/01798

§ 371 Date: Dec. 28, 2005

(30) Foreign Application Priority Data
Jul. 11, 2003 (FR) 03/50324

(51) Int. Cl. H01B 1/12

(52) U.S. Cl. 252/500

(57) ABSTRACT

The invention concerns a mixed electronic and O²⁻ anion conductive perovskite material, of formula (I): A^{(a)}₍₁₋ₓ₋ᵤ₎A′^{(a-1)}ₓA″^{(a″)}ᵤB^{(b)}_{(1-s-y-v)}B^{(b+1)}ₛB′^{(b+β)}_{y}B″^{(b″)}ᵥO_{3-d}, wherein: a, a−1, a″, b, b+1, b+β et b″ are integers representing respective valences of the atoms A, A′, A″, B, B′, B″; a, a″, b, b″, β, x, y, s, u, v et δ such that the electrical neutrality of the crystal lattice is preserved; A represents an atom selected among scandium, yttrium or in the families of lanthanides, actinides or alkaline-earth metals; A″ represents an atom selected among Al, Ga, In, or Tl; B, B′, B″ represents an atom selected among the transition metals, Al, In, Ga, Ge, Sb, Bi, Sn or Pb. The invention also concerns the method for preparing said material and its use as mixed conductive material of a catalytic membrane reactor, for use in synthesizing synthetic gas by oxidation of methane or natural gas.

The subject of the present invention is a mixed (electronic/O²⁻anion) conductive material of perovskite structure, its method of preparation and its use in a catalytic membrane reactor for carrying out the operation of reforming methane or natural gas into syngas (H₂/CO mixture).

Catalytic membrane reactors, hereafter called CMRs) formed from such ceramic materials allow the separation of oxygen from air, the diffusion of this oxygen in ionic form through the ceramic material and the chemical reaction of the latter with natural gas (mainly methane) on catalytic sites (Ni or noble metal particles) deposited on the membrane. The conversion of syngas into liquid fuel by the GTL (Gas to liquid) process requires an H₂/CO molar ratio of 2. This ratio of 2 can be obtained directly by a process involving a CMR.

The perovskite is a mineral of formula CaTiO₃ having a specific crystal structure that can be identified by XRD (X-ray diffraction). The unit cell of this compound is a cube whose corners are occupied by the Ca²⁺ cations, the center of the cube by Ti⁴⁺ cation and the center of the faces by the O²⁻ oxygen anions.

Oxides of the perovskites family are represented by the general formula ABO₃ in which A and B are metal cations, the sum of the charges of which is equal to +b. In principle, A is an element of the lanthanide group and B is a transition metal. By extension, any compound of formula ABO₃, in which A and B may be the abovementioned chemical elements or mixtures of these elements with other cations, and having the crystal structure described above, is called a perovskite.

The partial substitution of the elements A and B with elements A′ and B′ in order to form a perovskite compound of the A₁₋ₓA′ₓB_{1-y}B′yO₃ type entails many modifications within the material that it may prove to be particularly advantageous for the intended application.

U.S. Pat. No. 5,648,304 and U.S. Pat. No. 5,911,860 disclose mixed conductive materials of perovskite structure. However, these materials do not have a formulation and a method of synthesis that are suitable for optimum performance in a CMR application.

The Applicant therefore aims to develop a novel material displaying greater ionic conductivity than those of the prior art while still preserving stability over time.

Therefore, according to a first aspect, the subject of the invention is a mixed electronic/O²⁻-anion conductive material of perovskite crystal structure, characterized in that it consists essentially of a compound of formula (I):
ᵤA^{(a)}₍₁₋ₓ₋ₓA″^{(a″)}₎A′^{(a-1)}B^{(b)}_{u(1-s-y-v)}B^{(b+1)}ₛB′^{(b+β)}_{y}B″^{(b″)}ᵥO_{3-δ}, (I),
in which formula (I):

a, a−1, a″, b, b+1, b+β and b″ are integers representing the respective valences of the atoms A, A′, A″, B, B′ and B″; and a, a″, b, b″, β, x, y, s, u, v and δ are such that the electrical neutrality of the crystal lattice is preserved;
a>1;
a″, b and b″ are greater than zero;
−2≦β≦2;
a+b=6;
0<s<x;
0<x≦0.5;
0≦u≦0.5;
(x+u)≦0.5;
0≦y≦0.9;
0≦v≦0.9;
0≦(y+v+s)≦0.9;
[u(a″−a)+v(b″−b)−x+s+βy+2δ]=0;
and δₘᵢₙ<δ, <δₘₐₓ with
δₘᵢₙ=[u(a−a″)+v(b−b″)−βy]/2 and
δₘₐₓ=[u(a−a″)+v(b−b″)−βy+x]/2;
and in which formula (I):

A represents an atom chosen from scandium, yttrium or from the families of lanthanides, actinides or alkaline-earth metals;

A′, which differs from A, represents an atom chosen from scandium, yttrium or from the families of lanthanides, actinides or alkaline-earth metals;

A″, which is different from A and A′, represents an atom chosen from aluminum (Al), gallium (Ga), indium (In) and thallium (Tl) or from the families of alkaline-earth metals;

B represents an atom chosen from the transition metals that can exist in several possible valences;

B′, which differs from B, represents an atom chosen from transition metals, aluminum (Al), indium (In), gallium (Ga), germanium (Ge), antimony (Sb), bismuth (Bi), tin (Sn), lead (Pb) and titanium (Ti); and

B″, which differs from B and B′, represents an atom chosen from transition metals, metals of the alkaline-earth family, aluminum (Al), indium (In), gallium (Ga), germanium (Ge), antimony (Sb), bismuth (Bi), tin (Sn) and lead (Pb) or titanium (Ti).

The expression “family of alkaline-earth metals” is understood to mean, in the case of A, A′ or B″, an atom essentially chosen from magnesium (Mg), calcium (Ca), strontium (Sr) and barium (Ba).

The expression “family of lanthanides” is understood to mean, in the case of A, an atom essentially chosen from lanthanum (La), cerium (Ce), praseodymium (Pr), neodymium (Nd), samarium (Sm), europium (EU), gadolinium (Gd), terbium (Tb), dysprosium (Dy), holmium, erbium (Er), thulium (Tm), ytterbium (Yb) and lutetium (Lu).

The expression “transition metals that can exist in several possible variances” is understood to mean, in the case of B, metals possessing at least two possible adjacent oxidation states, and more particularly an atom chosen from titanium (Ti), vanadium (V), chromium (Cr), manganese (Mn), iron (Fe), cobalt (Co), nickel (Ni), copper (Cu), zirconium (Zr), molybdenum (Mo), ruthenium (Ru), rhodium (Rh), tantalum (Ta), tungsten (W), rhenium (Re), osmium (Os), iridium (Ir) and platinum (Pt).

The term “transition metal” is understood to mean, in the case of B′ or B″, an atom essentially chosen from titanium (Ti), vanadium (V), chromium (Cr), manganese (Mn), iron (Fe), cobalt (Co), nickel (Ni), copper (Cu) zinc (Zn), zirconium (Zr), niobium (Nb), molybdenum (Mo), ruthenium (Ru), rhodium (Rh), palladium (Pd), silver (Ag), hafnium (Hf), tantalum (Ta), tungsten (W), rhenium (Re), osmium (Os), iridium (Ir), platinum (Pt) and gold (Au).

According to a first particular aspect, the object of the invention is a material as defined above, for which, in formula (I), δ is equal to an optimum value δₒₚₜ that allows it to ensure an optimum ionic conductivity for sufficient stability under operating temperature and pressure conditions as a mixed ionic/electronic conductor.

As will be explained here, the diffusion of oxygen into the material which is the subject the present invention is facilitated by the presence of oxygen vacancies in the crystal lattice. Now, it has been found that the simple choice of the chemical composition in terms of the elements A, A′, A″, B, B′ and B″ does not fix the number of oxygen vacancies and that, consequently, this is not a sufficient condition to ensure both good ionic conductivity and good stability under the normal conditions of use, especially an operating temperature between about 600° C. and 1000° C.

According to a second particular aspect, the subject of the invention is a material as defined above, for which, in formula (I), a and b are equal to 3.

According to a third particular aspect, the subject of the invention is a material as defined above, in which, in formula (I), u is equal to zero.

According to a fourth particular aspect, the subject of the invention is a material as defined above, in which, in formula (I), u is different from zero.

According to a fifth particular aspect, the subject of the invention is a material as defined above, for which, in formula (I), the sum (y+v) is equal to zero.

According to a sixth particular aspect, the subject of the invention is a material as defined above, for which, in formula (I), the sum (y+v) is different from zero.

According a seventh particular aspect, the subject of the invention is a material as defined above, for which, in formula (I), A is chosen from La, Ce, Y, Gd, Mg, Ca, Sr or Ba and more particularly a material of formula (Ia):
La^{(III)}₍₁₋ₓ₋ᵤ₎A′^{(II)}ₓA″^{(a″)}ᵤB^{(III)}_{(1-s-y-v)}B^{(IV)}ₛB′^{(3+β)}_{y}B″^{(b″)}ᵥO_{3-δ} (Ia),
corresponding to formula (I) in which a and b are equal to 3 and A represents a lanthanum atom.

According to an eighth particular aspect, the subject of the invention is a material as defined above, for which, in formula (I), A′ is chosen from La, Ce, Y, Gd, Mg, Ca, Sr or Ba and more particularly a material of formula (Ib):
A^{(III)}₍₁₋ₓ₋ᵤ₎Sr^{(II)}ₓA″^{(a″)}ᵤB^{(III)}_{(1-s-y-v)}B^{(IVD}ₛB′^{(3+β)}_{y}B″^{(b″)}ᵥO_{3-δ} (Ib),
corresponding to formula (I) in which a and b are equal to 3 and A′ represents a strontium atom.

According to a ninth particular aspect, the subject of the invention is a material as defined above, for which, in formula (I), B is chosen from Fe, Cr, Mn, Co, Ni and Ti and more particularly the subject is a material of formula (Ic):
A^{(III)}₍₁₋ₓ₋ᵤ₎A′^{(II)}ₓA″^{(a″)}ᵤFe^{(III)}_{(1-s-y-v)}Fe^{(IV)}ₛB′^{(3+β)}_{y}B″^{(b″)}ᵥO_{3-δ} (Ic),
corresponding to formula (I) in which b=3 and B represents an iron atom.

According to a tenth particular aspect, the subject of the invention is a material as defined above, for which, in formula (I), B′ is chosen from Co, Ni, Ti, Mn, Cr, Mo, Zr, V and Ga.

According to an eleventh particular aspect, the subject of the invention is a material as defined above, for which, in formula (I), B″ is chosen from Ti of Ga and more particularly the subject is a material of formula (Id): La^{(III)}₍₁₋ₓ₎Sr^{(II)}ₓFe^{(III)}₍₁₋ₛ₋ᵥ₎Fe^{(IV)}ₛB″^{(b″)}ᵥO_{3-δ} (Id),

Corresponding to formula (I), in which a=b=3, u=0, B represents an iron atom, A a lanthanum atom and A′ a strontium atom.

According to a twelfth particular aspect, the subject of the invention is a material as defined above, for which, in formula (I), A″ is chosen from Ba, Ca, Al and Ga.

As examples of materials there are those for which formula (I) is either:
La^{(III)}₍₁₋ₓ₋ᵤ₎Sr^{(II)}ₓAl^{(III)}ᵤFe^{(III)}₍₁₋ₛ₋ᵥ₎Fe^{(IV)}ₛTiᵥO_{3-δ},
La^{(III)}₍₁₋ₓ₋ᵤ₎Sr^{(II)}ₓAl^{(III)}ᵤFe^{(III)}₍₁₋ₛ₋ᵥ₎Fe^{(IV)}ₛGaᵥO_{3-δ},
La^{(III)}₍₁₋ₓ₎Sr^{(II)}ₓFe^{(III)}₍₁₋ₛ₋ᵥ₎Fe^{(IV)}ₛTiᵥO_{3-δ},
La^{(III)}₍₁₋ₓ₎Sr^{(II)}ₓTi^{(III)}₍₁₋ₛ₋ᵥ₎Ti^{(IV)}ₛFeᵥO_{3-δ},
La^{(III)}₍₁₋ₓ₎Sr^{(II)}ₓFe^{(III)}₁₋ₛ₋ᵥ₎Fe^{(IV)}ₛGaᵥO_{3-δ} or
La^{(III)}₍₁₋ₓ₎Sr^{(II)}ₓFe^{(III)}₍₁₋ₛ₎Fe^{(IV)}ₛO_{3-δ},
and more particularly that of formula (Id) as defined above, in which x is equal to 0.4, B″ represents a trivalent gallium atom, v is equal to 0.1 and δ=0.2−(s/2) and preferably that in which δ is preferably equal to δₒₚₜ=0.180±0.018.

The subject of the invention is also a method of preparing a mixed electronic/O²⁻ anion conductive material of perovskite crystal structure, the electrical neutrality of the crystal lattice of which is preserved, represented by the crude formula (I′):
A₍₁₋ₓ₋ᵤ₎A′ₓA″ᵤB_{(1-y-v)}B′_{y}B″ᵥO_{3-δ}, (I′)
in which formula (I′):

x, y, u, v and δ are such that the electrical neutrality of the crystal lattice is preserved;
0<x≦0.5;
0≦u≦0.5;
(x+u)≦0.5;
0≦y≦0.9;
0≦v≦0.9;
0≦(y+v)≦0.9; and
0<δ
and in which formula (I′):

A represents an atom chosen from scandium, yttrium or from the families of lanthanides, actinides or alkaline-earth metals;

A′, which differs from A, represents an atom chosen from scandium, yttrium or from the families of lanthanides, actinides or alkaline-earth metals;

A″, which is different from A and A′, represents an atom chosen from aluminum (Al), gallium (Ga), indium (In) and thallium (Tl);

B represents an atom chosen from the transition metals that can exist in several possible valences;

B′, which differs from B, represents an atom chosen from transition metals, aluminum (Al), indium (In), gallium (Ga), germanium (Ge), antimony (Sb), bismuth (Bi), tin (Sn) and lead (Pb); and

B″, which differs from B and B′, represents an atom chosen from transition metals, metals of the alkaline-earth family, aluminum (Al), indium (In), gallium (Ga), germanium (Ge), antimony (Sb), bismuth (Bi), tin (Sn) and lead (Pb);

characterized in that it comprises the following successive steps:

a step (a) of synthesizing a powder having an essentially perovskite crystal phase from a blend of compounds consisting of at least one carbonate and/or of an oxide and/or of a nitrate and/or of a sulfate and/or of a salt of each of the elements A, A′ and B and, if necessary, of a carbonate and/or of an oxide and/or of a nitrate and/or of a sulfate and/or of a salt of A″, B′ and/or B″;

a step (b) of forming the powder blend obtained from step (a);

a step (c) of removing the binder from the formed material obtained from step (b); and

a step (d) of sintering the material obtained from step (c);

and characterized in that at least one of steps (a), (c) and (d) is carried out while controlling the oxygen partial pressure (pO₂) of the gaseous atmosphere surrounding the reaction mixture.

In formula (I′) as defined above, A is more particularly chosen from La, Ce, Y, Gd, Mg, Ca, Sr and Ba and, in this case, the material prepared by the method as defined above is preferably a material of formula of (I′a):
La₍₁₋ₓ₋ᵤ₎A′ₓA″ᵤB_{(1-y-v)}B′_{y}B″ᵥO_{3-δ} (I′a)
corresponding to formula (I′) in which A represents a lanthanum atom.

In formula (I′) as defined above, A′ is more particularly chosen from La, Ce, Y, Gd, Mg, Ca, Sr, and Ba and, in this case, the material prepared by the method as defined above is preferably a material of formula (I′b):
A₍₁₋ₓ₋ᵤ₎SrₓA″ᵤB_{(1-y-v)}B′_{y}B″ᵥO_{3-δ} (I′b),
corresponding to formula (I′), in which a and b are equal to 3 and A′ represents a strontium atom.

In formula (I′) as defined above, B is more particularly chosen from Fe, Cr, Mn, Co, Ni and Ti and, in this case, the material prepared by the method as defined above is preferably a material of formula (I′c):
A₍₁₋ₓ₋ᵤ₎A′ₓA″ᵤFe_{(1y-v)}B′_{y}B″ᵥO_{3-δ} (I′c),
corresponding to formula (I′) in which b=3 and B represents an iron atom.

The method as defined above is preferably used to prepare a material of formula (I′d):
La₍₁₋ₓ₎SrₓFe₍₁₋ᵥ₎B″ᵥO_{3-δ} (I′d),
corresponding to formula (I′) in which a=b=3, u=0, y=0, B represents an iron atom, A a lanthanum atom, A′ a strontium atom and B″ is chosen from Ti and Ga. In general, before step (a) of the method defined above is carried out, the high-purity precursor powders are washed beforehand and/or dried and/or heated to 600° in order to extract the volatile compounds and the adsorbed water. They are then weighed and mixed in the appropriate proportions for obtaining the desired blend. The blend of precursors is then milled by attrition in the presence of a solvent, in order to obtain a fine homogeneous blend. After drying, the resultant powder is subject to step (a).

Step (a) generally consists of a calcination, which takes place in a temperature generally between 800° C. and 1500° C., preferably between 900 and 1200° C., for 5 h to 15 h in air or in a controlled atmosphere. XRD analysis is then used to verify the state of reaction of the powders. If necessary, the powder is milled further and then calcined according to the same protocol until the precursors have completely reacted and the desired perovskite phase has been obtained.

After step (a) of the method as defined above, the powder has a predominantly perovskite phase and possibly a small amount of secondary phases (reactivity between some of the precursors, resulting in suboxides) varying between 0 and 10% by volume. The nature and the fraction of these phases may vary depending on the temperatures reached, on the homogeneity of the blend or the type of atmosphere used.

After the forming step (b), the powder formed may be milled in order to match the size, shape and specific surface area of the grains to the forming protocol used. The particle size of the powder is checked by particle size analysis or by SEM or by any other specific apparatus.

The forming step (b) may consist of:

an extrusion operation, for example to form cellular structures or sheets or tubes;

a coextrusion operation, for example to form porous tubes or sheets or a dense membrane;

a pressing operation, for example to form tubes or disks or cylinders or sheets; or

a strip casing operation, for example to form sheets that may subsequently be cut up.

These methods in general require additions of organic compounds such as binders and plasticizers that impart flow properties suitable for the process and favorable mechanical properties so that the object can be handled in the green state, that is to say before sintering.

The removal of the organic components requires a heat treatment step prior to sintering. This step (c), called the binder removal step, is carried out in an oven in air or in a controlled atmosphere, with a suitable thermal cycle, generally by pyrolysis with a slow heating rate up to a hold temperature of between 200 and 700° C., preferably between 300° C. and 500° C. After this step, the relative density of the membrane must be at least 55% in order to facilitate densification of the object during sintering.

The sintering step (d) is carried out between 800 and 1500° C., preferably between 1000° C. and 1400° C. for 2 to 3 hours in a controlled (pO₂) atmosphere and on a support between which and the material there is little or no interaction. Supports made of aluminum (Al₂O₃) or magnesium (MgO), or a bed of coarse powder of the same material, will therefore be preferably used. After this step, the membranes must be densified to at least 94% so as to be impermeable to any type of molecular gas diffusion.

According to a first particular way of implementing the method as defined above, the powder obtained at step (a) is formed by tape casting (step b). By introducing suitable organic compounds as binder (for example a methacrylate resin or PVB), dispersants (for example a phosphoric ester) and plasticizer (for example dibutylphthalate) it is possible to obtain a tape of controlled thickness (between 100 and 500 μm). This tape may be cut into disks 30 mm in diameter. These disks may be stacked and thermocompression-bonded at 65° C. under a pressure of 50 MPa for 5 to 6 minutes so as to obtain greater thicknesses. The membranes then undergo the binder removal step (step c) and are sintered (step d).

According to a second particular way of implementing the method as defined above, step (c) is carried out while monitoring the oxygen partial pressure (pO₂) of the gaseous atmosphere surrounding the material undergoing binder removal.

In a third particular way of implementing the method as defined above, step (d) is carried out in a gaseous atmosphere having a controlled oxygen partial pressure of between 10⁻⁷ Pa and 10⁵ Pa, preferable close to 0.1 Pa, and in this case step (a) is preferably carried out in air.

According to another aspect, the subject of the invention is a material of formula (I′), as defined above, and particularly a material of formula (I′a), (I′b), (I′c) or (I′d) in which δ depends on the oxygen partial pressure in the gaseous atmospheres in which steps (a), (d) and optionally (c) of the method as defined above take place.

Finally, the subject of the invention is the use of the material as defined above as mixed conductive material (electronic and ionic conductor) of a catalytic membrane reactor designed to be used to synthesize syngas by the oxidation of methane or natural gas.

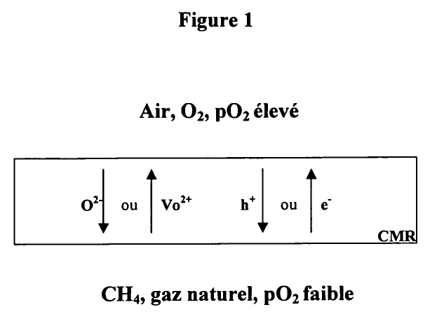

FIG. 1 is a schematic representation of the anion and electron diffusion through the catalytic membrane reactor in operation.

The following description illustrates the invention without however limiting it.

Preparation of a Material of Formula La_{0.6} Sr_{0.4} Fe_{0.9} Ga_{0.1} O_{3-δ}

Synthesis of the Material

A powder blend, preheated in order to remove any residual water or gaseous impurities, was prepared, said blend comprising:

44.18 g of La₂O₃ (from Ampere Industrie™: purity >99.99% by weight);

26.69 g of SrCO₃ (from Solvay Baris™: purity >99% by weight);

32.81 g of Fe₂O₃ (from Alfa Aesar™; purity >99% by weight);

4.28 g of Ga₂O₃ (from Sigma Aldrich™; purity >99% by weight).

The blend was milled in a polyethylene jar fitted with a rotating blade made of the same material together with spherical balls made of yttria-stabilized zirconia (YSZ), an aqueous or organic solvent and optionally a dispersant.

This attrition milling resulted in a homogeneous blend of powder particles of smaller diameter and of relatively spherical form and with a monomodal particle size distribution. After this first milling operation, the mean diameter of the particles was between 0.3 μm and 2 μm. The contents of the jar were passed through a screen with a mesh size of 200 μm in order to separate the powder from the balls. This screened powder was dried and stored before being calcined.

The powder blend obtained was calcined on an alumina refractory in a furnace. The partial oxygen pressure of the atmosphere was set by circulating an appropriate gas or gas mixture in the furnace. The oxygen partial pressure was monitored so as to remain within the [10⁻⁷ Pa to 10⁵ Pa] range. The furnace was flushed with a gas mixture before the temperature rise was started, in order to establish the desired partial oxygen pressure, this being monitored by an oxygen probe or a chromatograph placed at the outlet of the furnace.

The gas mixture was composed of 0 to 100% oxygen, the balance being another type of gas, preferably argon or nitrogen or carbon dioxide. The temperature was then increased up to a hold temperature between 900° C. and 1200° C. and held there for 5 h to 15 h. The rate of temperature rise was typically between 5° C./min and 15° C./min, while the rate of fall was governed by the natural cooling of the furnace.

XRD analysis was then used to check the state of reaction of the powders. Optionally, the powder was further milled and/or calcined using the same protocol until the reaction of the precursors was complete and the desired perovskite phase obtained.

The perovskite powder obtained was formed by the conventional methods used for ceramics. Such methods systematically rely on additions of organic compounds that have to be extracted by pyrolysis (step c: binder removal) before the actual sintering step and high temperature (step d).

The resulting ceramic part was introduced into the furnace, the oxygen partial pressure of which was controlled as in the previous calcination step. The temperature was increased slowly, at about 0.1° C./min to 2° C./min until a first hold temperature of between 300° C. and 500° C. was reached (the binder removal step c). The hold time varied between 0 and 5 h depending on the conditions used and the volume of the part. This operation was carried out either in a controlled atmosphere or an uncontrolled atmosphere. The oxygen content was between 10⁻⁷ Pa and 10⁵ Pa, preferably not exceeding 0.1 Pa. Once the oxygen partial pressure of the enclosure had been established, the temperature was increased up to the sintering temperature, generally between 1000° C. and 1400° C. with a hold lasting 1 to 3 hours, the oxygen partial pressure in the furnace being controlled. Upon return to room temperature, the relative density of the parts was checked, and also the absence of cracks, in order to guarantee impermeability of the membrane.

The two main preparation steps (synthesis (step a) and sintering (step d)) were carried out in air (pO₂=2·10⁴ Pa or in nitrogen (pO₂=0.1 Pa). The temperatures at which the flows were measured varied between 500 and 1000° C. The oxidizing and reducing gases used in this example were air and argon, respectively. The measurements were carried out over several hours of operation.

The oxygen contents in the argon downstream of the thermal chamber were measured using an oxygen probe and/or a gas chromatograph (GC).

Table 1 shows the influence of the synthesis protocol on a material described in the present invention.

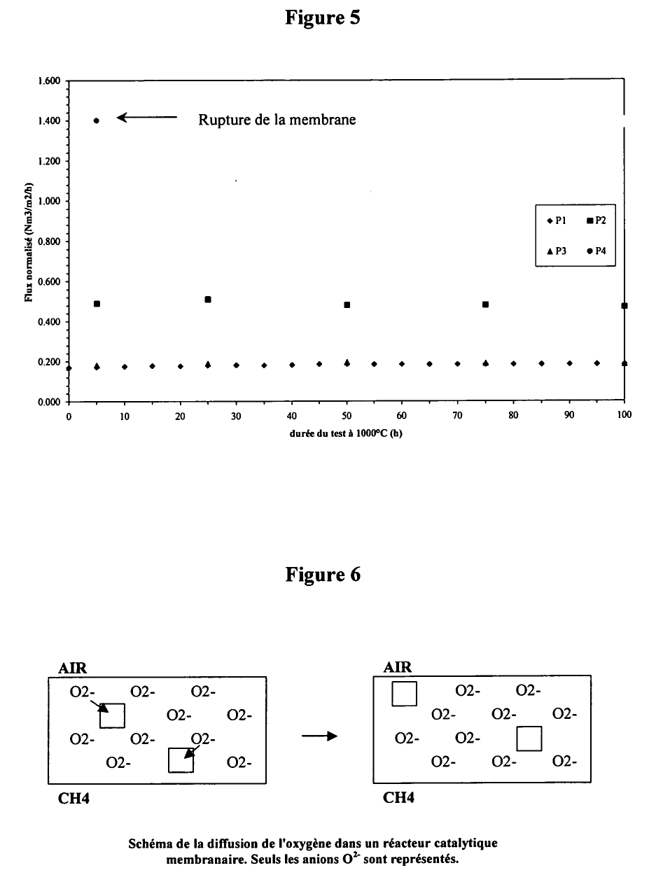

FIG. 5 shows the stability of the oxygen permeation flux over more than 100 h of operation for an air/argon mixture at 1000° C. and atmospheric pressure on both sides.

TABLE 1

| | | | Oxygen flux | Oxygen flux |
|---|---|---|---|---|
| | | pO₂ | at 500° C. | at 1000° C. |
| Protocol | Synthesis | (Pa) | (Nm³/m²/h) | (Nm³/m²/h) |
| P1 | Calcination | 2 · 10⁴ | ≈0 | 0.17 |
| | Sintering | 2 · 10⁴ | | |
| P2 | Calcination | 2 · 10⁴ | 0.10 | 0.51 |
| | Sintering | 0.1 | | |
| P3 | Calcination | 0.1 | ≈0 | 0.18 |
| | Sintering | 2 · 10⁴ | | |
| P4 | Calcination | 0.1 | | 1.5 then CMR |
| | Sintering | 0.1 | 0.25 | cracking |
| | | | | (unstable |
| | | | | system) |

Characterization by X-Ray Diffraction (XRD

The XRD analyses on the bulk or pulverulent specimens were carried out at various steps in the synthesis protocol (after calcination, before sintering or post mortem) and were used to check the nature of the material (phase, crystal system) and its evolution according to the protocol.

Determination of the Substoichiometry by TGA (Thermogravimetric Analsysis)

The substoichiometry of the material, that is to say the value of δ in the formula described in this invention, was determined according to the synthesis protocol employed by measuring the weight loss or increase as a function of the temperature and the oxygen partial pressure. The powders have to be dried beforehand so that the change in weight can be ascribed only to oxygen exchange with the atmosphere.

The powder or the sintered material reduced to a powder and dried, was placed in an alumina crucible in the thermobalance compartment provided for this purpose. The thermal program and the oxygen partial pressure of the medium were controlled in accordance with those of the material calcination or sintering protocol. The signal corresponding to the change in mass recorded as a function of the temperature for a fixed oxygen partial pressure was used to deduce the oxygen substoichiometry of the material.

Analysis of the Oxygen Flux Passing Through the Membrane

Flux tests were carried out with parts in the form of thin disks 30 mm in diameter and between 0.1 and 2 mm in thickness, these being prepared as indicated above.

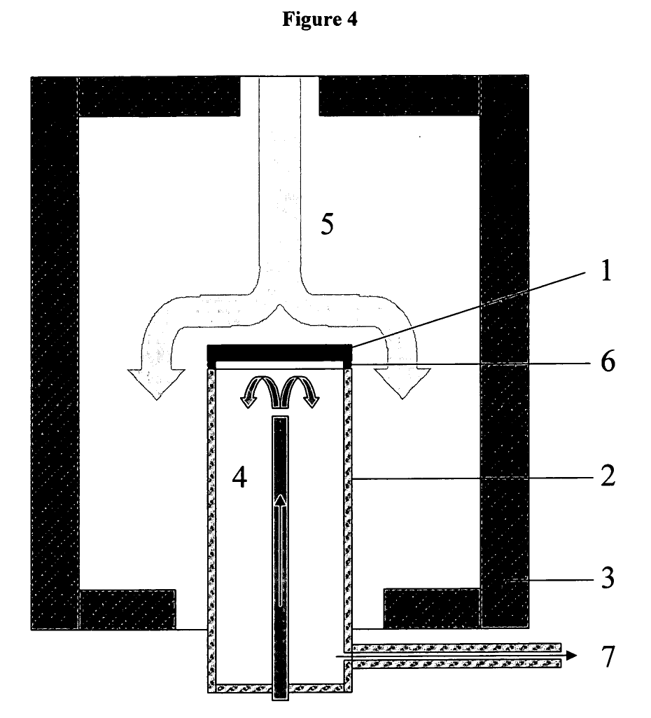

These membranes were placed within the device as shown in FIG. 4, which is a schematic sectional representation of the reactor used. The membranes (1) had a diameter of around 25 mm and a thickness varying between 0.1 and 2 mm. They were positioned individually on the top of an alumina tube (2) placed in a thermal chamber (3). The dense alumina tube contained a controlled atmosphere (4) acting as reducing agent in operation (inert or reducing gas). The opposite face of the membrane was swept with an oxidizing atmosphere (5) (air or an atmosphere of variable pO₂). Sealing between the two atmospheres was guaranteed at high temperature by the presence of an impermeable seal (6) between the alumina tube and the membrane. An oxygen probe or a chromatograph placed in the reducing gas circuit and after the membrane (7) was used to measure the oxygen flux through the material.

The oxygen flux was calculated and normalized to the temperature and pressure conditions using the following formula:

$${J}_{{O}_{2}} = \frac{C \times D}{S} \times α$$

in which:
J_{O}_{₂} is the oxygen flux through the membrane (Sm³/m²/h);
C is the O₂ concentration measured at the outlet (ppm);
D is the carrier gas flow rate (m³/h);
S is the effective area of the membrane (m²); and
α is the volume normalization coefficient [for which Tₙₒᵣₘₐₗ=273 K; Pₙₒᵣₘₐₗ=10⁵ Pa (1013 mbar)]:

$$α = \frac{{P}_{measured} \cdot {T}_{normal}}{{P}_{normal} \cdot {T}_{measured}} .$$

Discussion

The influence of the atmospheres used for the heat treatments (calcination, binder removal and sintering) on the ionic conduction properties of material was mentioned previously. Although the atmospheres of the various heat treatments allow a suitable amount of oxygen vacancies to be created, the overall stoichiometry of the material will not change in operation and will be stable. This is because the oxygen leaves the material on the reducing side, but is immediately replaced with the oxygen from the air on the oxidizing side, so that the overall content of vacancies is unchanged.

It is therefore paramount that the quantity of these vacancies be adjusted before the membrane is used as such.

In the case of the materials according to the present invention, the oxygen substoichiometry is provided by a preparation step, whether this be the synthesis (or calcination, step a) and/or sintering (step d) (the latter including the binder removal cycle of step e)) at high temperature (>900° C.) in a controlled atmosphere having a low controlled oxygen partial pressure. The thermal chamber may in this regard be swept with an inert gas (e.g. N₂ or Ar) or a reducing gas (e.g. H₂/N₂ or H₂/He) or it may be in a dynamic vacuum.

Among these possibilities, sweeping the furnace with an inert gas is preferred.

The blend of precursors may be calcined in air or in an inert gas, and then sintered in an inert gas (controlled pO₂<0.2). The change in oxygen content of the lattice may be monitored by XRD (X-ray diffraction) or by TGA (thermogravimetric analysis).

Specifically, the appearance of vacancies in the crystal lattice of the material modifies its structure and/or its crystal properties. XRD then reveals:

either a change in the crystal system (for example from a rhombohedral perovskite for a low vacancy content to a cubic perovskite for a higher vacancy content); and

systematically, a change in the lattice parameters, which increase with the substoichiometry.

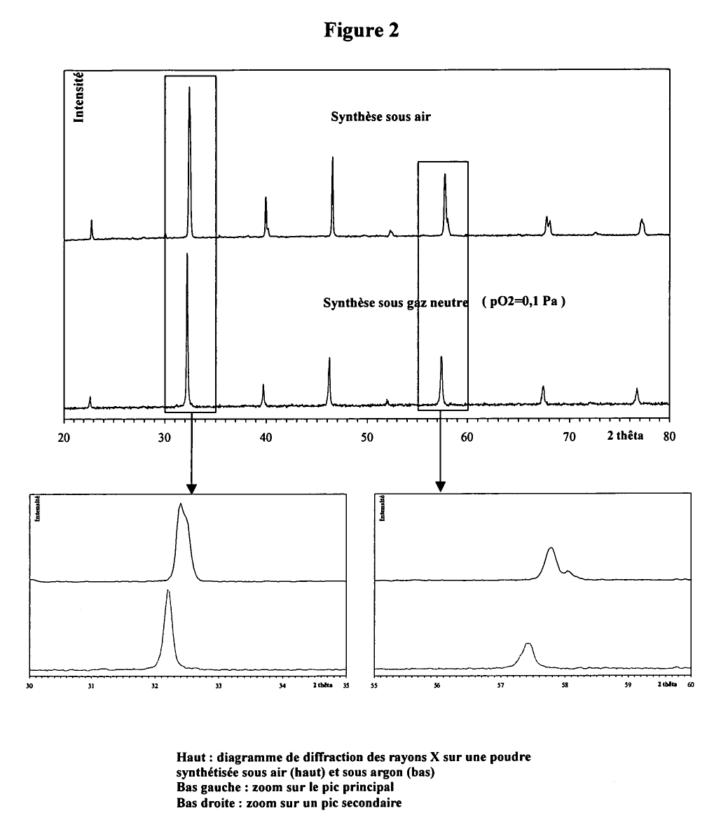

FIG. 2 shows the X-ray diffraction diagrams for polycrystalline specimens and brings out the influence of the oxygen partial pressure during synthesis on the structure of the material. In this example, the material synthesized in air does not have the same crystal system as material synthesized in argon. This in fact shows that all the peaks of the material synthesized in argon are narrow whereas some of the peaks of the material synthesized in air are double peaks (they have a shoulder). The material synthesized in argon thus has a cubic symmetry whereas that synthesized in air has a rhombohedral symmetry.

It is known that the repulsion between cations is greater in a substoichiometric material, this having the effect of increasing the volume of the unit cell. As a result, in this diagram all the lines are shifted toward smaller angles.

The loss of oxygen in the material is also manifested by a loss of mass, the amount of which, measured by TGA, allows the final vacancy content to be estimated.

All the above remarks about the benefit of using synthesis atmospheres having a low controlled pO₂ are of course valid only in the case of materials withstanding such atmospheres.

The claimed materials are therefore stable under the temperature and oxygen partial pressure conditions used during the various synthesis steps, that is to say they retain their chemical stability and their overall perovskite formula. After the various synthesis steps, it is therefore desirable to check, for example by XRD, that the material has not decomposed, either completely or partially.

The synthesis protocol in an atmosphere having a controlled pO₂ also offers another advantage, that of greatly reducing the presence of secondary phases in the sintered membrane.

This is because the synthesis of a powder from precursors rarely results in the formation of a single phase. These secondary phases may indirectly reduce the performance of the material since their presence modifies the formulation of the main phase by depleting it of certain elements. Now, as it is difficult to predict in advance what the proportion and the nature of secondary phases will be exactly, the formulation of the final material cannot be guaranteed from an adjustment of the initial amounts of precursors.

The secondary phases included in our materials sintered in air are compounds of the ABO₃, AB₂O₄, A₂BO₄ type or mixed AA′BO₃, ABB′O₃ or AA′BB′O₃ compounds. Now, for the majority of cases, these phases are unstable at the low oxygen partial pressures, so that the proportion of secondary phases is greatly reduced by treatment at a pO₂<2·10⁴ Pa.

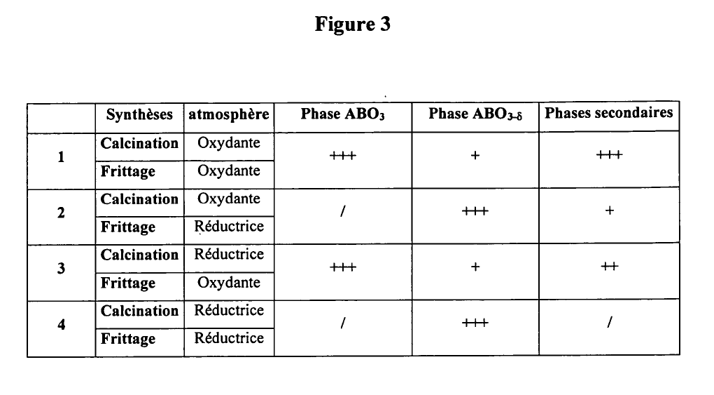

FIG. 3 illustrates the influence of the preparation protocol (synthesis and sintering) on the nature of the phases present in the material. It demonstrates in particular the benefit of sintering the material at low oxygen partial pressures in order to favor the presence of a substoichiometric phase and reduce the presence of inclusions, which deplete the material of certain elements on which the conduction properties depend.

In addition, when the material is sintered in an oxidizing atmosphere, for example in air, the oxygen substoichiometry of material is low, which has negative repercussions on the flux. These negative repercussions are greater as the sintering in air favors the appearance of inclusions.

It may be envisaged to subject the material sintered in air to an inert atmosphere before using it as a catalyst, however, the microstructural changes that result therefrom cause the membrane to crack.

It is clearly apparent that the search for a mixed conductive perovskite material of useful performance cannot be assumed just from its formulation. The present invention demonstrates the influence of the preparation protocol on its performance, especially the synthesis step (step a) and/or the sintering step (step d) at low oxygen partial pressures (vacuum, inert or reducing gases).

This change in flux performance (=ionic conductivity of the O²⁻ ions+electronic conductivity) is directly due to the presence of oxygen vacancies in the crystal sublattice. The constituent ions of the material, for example La³⁺, Sr²⁺, Fe³⁺, Ga³⁺ and O²⁻, are organized in a particular structure described by a perovskite unit cell. The oxygen anions occupy sites specific to them in this unit cell when one of these sites is empty—there is therefore a vacancy in the crystal lattice.

When the material is used as a CMR, a difference in partial pressure on each side of the membrane is the driving force for the diffusion of oxygen through the crystal lattice, this diffusion being possible only at high temperatures. The presence of vacancies within the oxygen sublattice increases the diffusion rate of the anions and lowers the activation energy of (or the temperature for) this diffusion. FIG. 6 illustrates the diffusion of oxygen in such a catalytic membrane reactor.

It will therefore be understood that the material has to have oxygen vacancies within it in order to be used for a CMR application.

This search for a substoichiometry in the material is firstly achieved by its initial formulation especially by doping the material with an element likely to create vacancies. Then, secondly, the substoichiometry is obtained by the preparation protocol.

In the example described above, it is strontium that acts as a dopant element on lanthanum. Sr²⁺ has an ionic radius similar to that of La³⁺, so that it is incorporated into the lattice of the perovskite. However, its charge is different since it possesses an additional electron. The substitution of lanthanum with strontium therefore causes an electronic overcharge, which is immediately compensated for by the crystal so as to preserve its neutrality. According to a first mechanism, this compensation is provided by the removal of oxygen, which creates positively charged vacancies so that the positive charges cancel out the negative charges. The formula is then the following:
La₁₋ₓSrₓFeO_{3-x/2} or La^{(III)}₁₋ₓSr^{(II)}xFe^{(III)}O^{(-II)}_{3-x/2},
where x is the degree of substitution of strontium with lanthanum.

The neutrality equation is therefore as follows:
3(1−x)+2x+3−2(3x/2)=0

A second mechanism allows the negative charges to be compensated for by the change in valency of the iron. Iron⁺⁺⁺ captures the excess electron and becomes iron^{IV}.

If the change of valency of the iron takes place preferentially in the presence of a vacancy, the material may be stoichiometric and thus not have the satisfactory performance. In this case, the formula is:
La₁₋ₓSrₓFeO₃ or La^{(III)}₁₋ₓSr^{(II)}ₓFe^{(III)}₁₋ₓFe^{(IV)}ₓO^{(-II)}₃,
where x is the degree of substitution of strontium with lanthanum.

The neutrality equation is then given by:
3(1x)+2x+3(1−x)+4x−2.(3)=0.

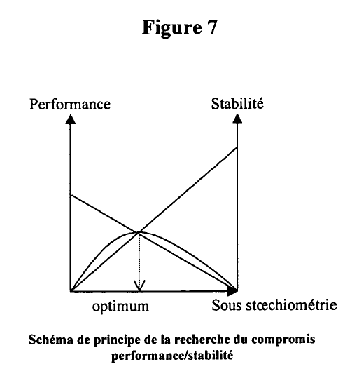

The stoichiometry of the material according to the invention varies between the two above extremes, depending on the surrounding oxygen partial pressure. By controlling the oxygen partial pressure during the various steps of preparing the material, and in particular during calcination and sintering, it is possible to achieve the optimum substoichiometry δₒₚₜ and an acceptable performance of conductivity, while preserving the stability of the material. The aim will therefore be for the material to lie at the maximum shown in the curve in FIG. 7, which illustrates the best flux/stability compromise. The notion of stability corresponds here to the vacancy content of the material being preserved during the operation on which its lifetime will depend.

1-26. (canceled)

27. A mixed electronic/O²⁻-anion conductive material of perovskite crystal structure, the electrical neutrality of the crystal lattice of which is preserved characterized in that it consists essentially of a compound of formula (I):
A^{(a)}₍₁₋ₓ₋ᵤ₎A′^{(a-1)}ₓA″^{(a″)}ᵤB^{(b)}_{(1-s-y-v)}B^{(b+1)}ₛB′^{(b+β)}_{y}B″^{(b″)}ᵥO_{3-δ}, (I)
in which formula (1):
a, a−1, a″, b, b+1, b+β and b″ are integers representing the respective valences of the atoms A, A′, A″, B, B′ and B″; and a, a″, b, b″, β, x, y, s, u, v and δ are such that the electrical neutrality of the crystal lattice is preserved;
a>1;
a″, b and b″ are greater than zero;
−2≦β≦2;
a+b=6;
0<s<x;
0<x≦0.5;
0≦u≦0.5;
(x+u)≦0.5;
O≦y≦0.9;
0≦v≦0.9;
0≦(y+v+s)≦0.9;
[u(a″−a)+v(b″−b)−x+s+βy+2δ]=0;
and δₘᵢₙ<δ<δₘₐₓ with
δₘᵢₙ=[u(a−a″)+v(b−b″)−βy]/2 and
δₘₐₓ=[u(a−a″)+v(b−b″)−βy+x]/2;
and in which formula (I):
A represents an atom chosen from scandium, yttrium or from the families of lanthanides, actinides or alkaline-earth metals;
A′, which differs from A, represents an atom chosen from scandium, yttrium or from the families of lanthanides, actinides or alkaline-earth metals;
A″, which is different from A and A′, represents an atom chosen from aluminum (Al), gallium (Ga), indium (In) and thallium (Tl);
B represents an atom chosen from the transition metals that can exist in several possible valences;
B′, which differs from B, represents an atom chosen from transition metals, aluminum (Al), indium (In), gallium (Ga), germanium (Ge), antimony (Sb), bismuth (Bi), tin (Sn) and lead (Pb); and
B″, which differs from B and B′, represents an atom chosen from transition metals, metals of the alkaline-earth family, aluminum (Al), indium (In), gallium (Ga), germanium (Ge), antimony (Sb), bismuth (Bi), tin (Sn) and lead (Pb).

28. The material as defined in claim 27, for which, in formula (I), δ is equal to an optimum value δₒₚₜ that allows it to ensure an optimum ionic conductivity for sufficient stability under operating temperature and pressure conditions as a mixed ionic/electronic conductor.

29. The material as defined in claim 27, for which, in formula (I), a and b are equal to 3.

30. The material as defined in claim 27, in which, in formula (I), u is equal to zero.

31. The material as defined in claim 27, in which, in formula (I), u is different from zero.

32. The material as defined in claim 27, for which, in formula (I), the sum (y+v) is equal to zero.

33. The material as defined in claim 27, for which, in formula (I), the sum (y+v) is different from zero.

34. The material as defined claim 27, for which, in formula (I), A is chosen from La, Ce, Y, Gd, Mg, Ca, Sr or Ba.

35. The material as defined in claim 34, of formula (Ia):
La^{(III)}₍₁₋ₓ₋ᵤ₎A′^{(II)}ₓA″^{(a″)}ᵤB^{(III)}_{(1-s-y-v)}B^{(IV)}ₛB′^{(3+β)}_{y}B″^{(b″)}ᵥO_{3-δ} Ia),
corresponding to formula (I) in which a and b are equal to 3 and A represents lanthanum.

36. The material as defined in claim 27, for which, in formula (I), A′ is chosen from La, Ce, Y, Gd, Mg, Ca, Sr or Ba.

37. The material as defined in claim 36, of formula (Ib):
A^{(III)}₍₁₋ₓ₋ᵤ₎Sr^{(II)}ₓA″^{(a″)}ᵤB^{(III)}_{(1-s-y-v)}B^{(IV)}ₛB′^{(3+β)}_{y}B″^{(b″)}ᵥO_{3-δ} (Ib),
corresponding to formula (I) in which a and b are equal to 3 and A′ represents strontium.

38. The material as defined in claim 27, for which, in formula (I), B is chosen from Fe, Cr, Mn, Co, Ni and Ti.

39. The material as defined in claim 12, of formula (Ic):
A^{(III)}₍₁₋ₓ₋ᵤ₎A′^{(II)}ₓA″^{(a″)}ᵤFe^{(III)}_{(1-s-y-v)}Fe^{(IV)}ₛB′^{(3+β)}_{y}B″^{(b″)}ᵥO_{3-δ} (IC),
corresponding to formula (I) in which b=3 and B represents an iron atom.

40. The material as defined in claim 27, for which, in formula (I), B′ is chosen from Co, Ni, Ti and Ga.

41. The material as defined in claim 27, for which, in formula (I), B″ is chosen from Ti or Ga.

42. The material as defined in claim 41, of formula (Id),
La^{(III)}₍₁₋ₓ₎Sr^{(II)}ₓFe^{(III)}₍₁₋ₛ₋ᵥ₎Fe^{(IV)}ₛB″^{(b″)}ᵥO_{3-δ} (Id),
corresponding to formula (I) in which a=b=3, u=0, y=0, B represents an iron atom, A is a lanthanum atom and A′ is a strontium atom.

43. The material as defined in claim 27, for which, in formula (I), A″ is chosen from Ba, Al and Ga.

44. The material as defined in claim 27, for which formula (I) is either:
La^{(III)}₍₁₋ₓ₋ᵤ₎Sr^{(II)}ₓAl^{(III)}ᵤFe^{(III)}₍₁₋ₛ₋ᵥ₎Fe^{(IV)}ₛTiᵥO_{3-δ},
La^{(III)}₍₁₋ₓ₋ᵤ₎Sr^{(II)}ₓAl^{(III)}ᵤFe^{(III)}₍₁₋ₛ₋ᵥ₎Fe^{(IV)}ₛGaᵥO_{3-δ},
La^{(III)}₍₁₋ₓ₎Sr^{(II)}ₓFe^{(III)}₍₁₋ₛ₋ᵥ₎Fe^{(IV)}ₛTiᵥO_{3-δ},
La^{(III)}₍₁₋ₓ₎Sr^{(II)}ₓFe^{(III)}₍₁₋ₛ₋ᵥ₎Fe^{(IV)}ₛGaᵥO_{3-δ}, or
La^{(III)}₍₁₋ₓ₎Sr^{(II)}ₓFe^{(III)}₍₁₋ₛ₎Fe^{(IV)}ₛO_{3-δ}.

45. The material of formula (Id) as defined in claim 42, in which x is equal to 0.4, B″ represents a trivalent gallium atom, v is equal to 0.1 and δ=0.2−(s/2) and δ is preferably equal to δₒₚₜ=0.180±0.018.

46. A method of preparing a mixed electronic/O²⁻ anion conductive material of perovskite crystal structure, the electrical neutrality of the crystal lattice of which is preserved, represented by the crude formula (I′):
A₍₁₋ₓ₋ᵤ₎A′ₓA″ᵤB_{(1-y-v)}B′_{y}B″ᵥO_{3-δ}, (I′)
in which formula (I′):
x, y, u, v and δ are such that the electrical neutrality of the crystal lattice is preserved;
0<x≦0.5;
0≦u≦0.5;
(x+u)≦0.5;
0≦y≦0.9;
0≦v≦0.9;
0≦(y+v)≦0.9; and
0<δ
and in which formula (I′):
A represents an atom chosen from scandium, yttrium or from the families of lanthanides, actinides or alkaline-earth metals;
A′, which differs from A, represents an atom chosen from scandium, yttrium or from the families of lanthanides, actinides or alkaline-earth metals;
A″, which is different from A and A′, represents an atom chosen from aluminum (Al), gallium 9Ga), indium (In) and thallium (Tl);
B represents an atom chosen from the transition metals that can exist in several possible valences;
B′, which differs from B, represents an atom chosen from transition metals, aluminum (Al), indium (In), gallium (Ga), germanium (Ge), antimony (Sb), bismuth (Bi), tin (Sn) and lead (Pb); and
B″, which differs from B and B′, represents an atom chosen from transition metals, metals of the alkaline-earth family, aluminum (Al), indium (In), gallium (Ga), germanium (Ge), antimony (Sb), bismuth (Bi), tin (Sn) and lead (Pb);
characterized in that it comprises the following successive steps:
a step (a) of synthesizing a powder having an essentially perovskite crystal phase from a blend of compounds consisting of at least one carbonate and/or of an oxide and/or of a sulfate and/or of a nitrate and/or of a salt of each of the elements A, A′ and B and, if necessary, of a carbonate and/or of an oxide of A″, B′ and/or B″;
a step (b) of forming the powder blend obtained from step (a);
a step (c) of removing the binder from the formed material obtained from step (b); and
a step (d) of sintering the material obtained from step (c);
and characterized in that at least one of steps (a), (c) and (d) is carried out while controlling the oxygen partial pressure (pO₂) of the gaseous atmosphere surrounding the reaction mixture.

47. The method as defined in claim 46, characterized in that step (c) is carried out while controlling the oxygen partial pressure (pO₂) of the gaseous atmosphere surrounding the material from which the binder is to be removed.

48. The method as defined in claim 46, in which step (d) is carried out in a gaseous atmosphere having an oxygen partial pressure not exceeding 0.1 Pa.

49. The method as defined in claim 48, in which step (a) is carried out in air.

50. A mixed electronic/O²⁻ anion conductive material of perovskite crystal structure, the electrical neutrality of the crystal lattice of which is preserved, represented by the crude formula (I′):
A₍₁₋ₓ₋ᵤ₎A′ₓA″ᵤB_{(1-y-v)}B′_{y}B″ᵥO_{3-δ}, (I′)
in which formula (I′):
x, y, u, v and δ are such that the electrical neutrality of the crystal lattice is preserved;
0<x≦0.5;
0≦u≦0.5;
(x+u)≦0.5;
0≦y≦0.9;
0≦v≦0.9;
0≦(y+v)≦0.9; and
0<δ
and in which formula (I′):
A represents an atom chosen from scandium, yttrium or from the families of lanthanides, actinides or alkaline-earth metals;
A′, which differs from A, represents an atom chosen from scandium, yttrium or from the families of lanthanides, actinides or alkaline-earth metals;
A″, which is different from A and A′, represents an atom chosen from aluminum (Al), gallium (Ga), indium (In) and thallium (Tl);
B represents an atom chosen from the transition metals that can exist in several possible valences;
B′, which differs from B, represents an atom chosen from transition metals, aluminum (Al), indium (In), gallium (Ga), germanium (Ge), antimony (Sb), bismuth (Bi), tin (Sn) and lead (Pb); and
B″, which differs from B and B′, represents an atom chosen from transition metals, metals of the alkaline-earth family, aluminum (Al), indium (In), gallium (Ga), germanium (Ge), antimony (Sb), bismuth (Bi), tin (Sn) and lead (Pb);
and in which δ depends on the oxygen partial pressure in the gaseous atmospheres in which steps (a), (d) and optionally (c) of the method as defined in one of claims 20 to 23 take place.

51. Use of the material as defined in claim 27 as mixed conductive material of a catalytic membrane reactor designed to be used to synthesize syngas by the oxidation of methane or natural gas.

52. Use of the material as defined in claim 27 as mixed conductive material of a ceramic membrane designed to be used to separate oxygen from air.
